(19) United States
(12) Patent Application Publication
(10) Pub. No.: US 2011/0018295 A1
(43) Pub. Date: Jan. 27, 2011

(54) Trolley wheel assembly

(76) Inventor: Todd Jager, Moville, IA (US)

Correspondence Address: THOMTE LAW OFFICE, L.L.C., 2120 S. 72ND STREET, SUITE 1111, OMAHA, NE, 68124, US

(21) Appl. No.: 12/456,385

(22) Filed: Jul. 27, 2009

(51) Int. Cl. B60B 19/00

(52) U.S. Cl. 295/35

(57) ABSTRACT

A trolley wheel assembly comprising a trolley bracket having a trolley wheel rotatably mounted therein. The trolley wheel has a central opening formed therein which receives a cylindrical bushing positioned therein. A pin means extends through the trolley bracket and the bushing to rotatably mount the trolley wheel on the trolley bracket. The bushing is comprised of a self-lubricating material as specifically described in the application.

### BACKGROUND OF THE INVENTION

1. Field of the Invention

This invention relates to a trolley wheel assembly and more particularly to a trolley wheel assembly for use on an overhead track. Even more particularly, this invention relates to a trolley wheel assembly having a bushing mounted therein which is comprised of a self-lubricating material. Even more particularly, this invention relates to specific self-lubricating bushing materials.

2. Description of the Invention

Trolley wheel assemblies are commonly used on overhead tracks to convey objects or products from one location to another location within a processing or manufacturing plant. The trolley wheels of the prior art are normally lubricated with grease or oil but the same poses a problem since the grease or oil may fall downwardly from the trolley wheel onto food products or the like, thereby contaminating the same.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A trolley wheel assembly is disclosed for use on an overhead track with the assembly including a trolley bracket having upper and lower ends. A trolley wheel is rotatably secured to the trolley bracket and has first and second sides and a groove formed in the periphery thereof adapted to receive the overhead track and to move thereon. The trolley wheel has a central opening formed therein. A cylindrical bushing is positioned in the central opening of the trolley wheel with a pin means being positioned in the bushing which is fixed to the trolley bracket. The bushing is comprised of a self-lubricating material. Preferably, the self-lubricating material is comprised of Torlon® which is comprised of a polyamide-imide material. The bushing may also be comprised of a laminate composite bearing material which is comprised of a laminated plastic material made by impregnating fabric with thermosetting resins. Preferably, the bushing is comprised of a non-metallic, high load, high impact, self-lubricating laminate material or the polyamide-imide material. In one embodiment, the bushing is comprised of textiles and thermosetting resins blended with graphite, moly, polytetrafluoroethylene (PTFE) and other lubricants. The trolley wheel assembly may be a single trolley wheel assembly of a double trolley wheel assembly.

The utilization of the bushing described herein provides a self-lubricating bushing without the need to oil or grease the same which eliminates the grease or oil or particles of the trolley wheel from dropping downwardly therefrom onto food products or the like thereby contaminating the same.

It is therefore a principal object of the invention to provide an improved trolley wheel assembly for use on an overhead track.

A further object of the invention is to provide a trolley wheel assembly including a bushing mounted within the trolley wheel which is comprised of a self-lubricating material.

A further object of the invention is to provide a trolley wheel assembly wherein the bushing is comprised of Torlon®.

A further object of the invention is to provide a trolley wheel assembly of the type described wherein the bushing is comprised of a polyamide-imide material.

A further object of the invention is to provide a trolley wheel assembly of the type described wherein the bushing is comprised of a laminate composite bearing material.

Still another object of the invention is to provide a trolley wheel assembly of the type described wherein the bushing thereof is comprised of a laminated plastic material made by impregnating fabric with thermosetting resins.

Still another object of the invention is to provide a trolley wheel assembly of the type described including a bushing which is comprised of a non-metallic, high load, high impact, self-lubricating, laminate material.

Yet another object of the invention is to provide a trolley wheel assembly of the type described including a bushing which is comprised of a CIP® material.

Yet another object of the invention is to provide a trolley wheel assembly of the type described including a bushing which is comprised of textiles and thermosetting resins blended with graphite, moly, PTFE and other lubricants.

Yet another object of the invention is to provide a trolley wheel assembly of the type described which prevents grease and/or oil from falling downwardly therefrom onto products therebelow.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a perspective view of a typical trolley wheel assembly having a bushing mounted therein which is comprised of the specific materials described hereinafter;

FIG. 2 is a side view of the trolley wheel assembly of FIG. 1;

FIG. 3 is a frontal view of the trolley wheel assembly of FIG. 1;

FIG. 4 is an exploded perspective view of one type of trolley wheel having the bushing of this invention mounted therein;

FIG. 5 is an exploded perspective view of a different type of trolley wheel having the bushing of this invention mounted therein;

FIG. 6 is a side view of the trolley wheel of FIG. 4;

FIG. 7 is an end view of the trolley wheel of FIG. 4;

FIG. 8 is a side view of the trolley wheel of FIG. 5;

FIG. 9 is an end view of the trolley wheel of FIG. 5;

FIG. 10 is a sectional view of the trolley wheel assembly of FIG. 1;

FIG. 11 is a perspective view of a double trolley wheel assembly with each of the trolley wheels thereof having the bushing of this invention mounted therein;

FIG. 12 is a side view of the trolley assembly of FIG. 11;

FIG. 13 is an end view of the trolley wheel assembly of FIG. 12;

FIG. 14 is a perspective view of a modified form of the trolley wheel having the bushing of this invention mounted thereon;

FIG. 15 is an end view of the trolley wheel assembly of FIG. 14; and

FIG. 16 is a side view of the trolley wheel assembly of FIG. 14.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

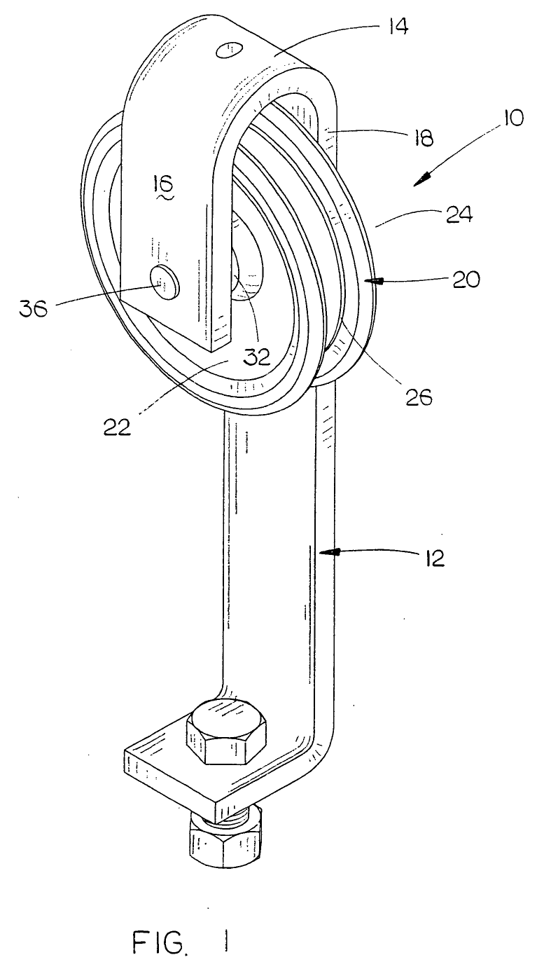

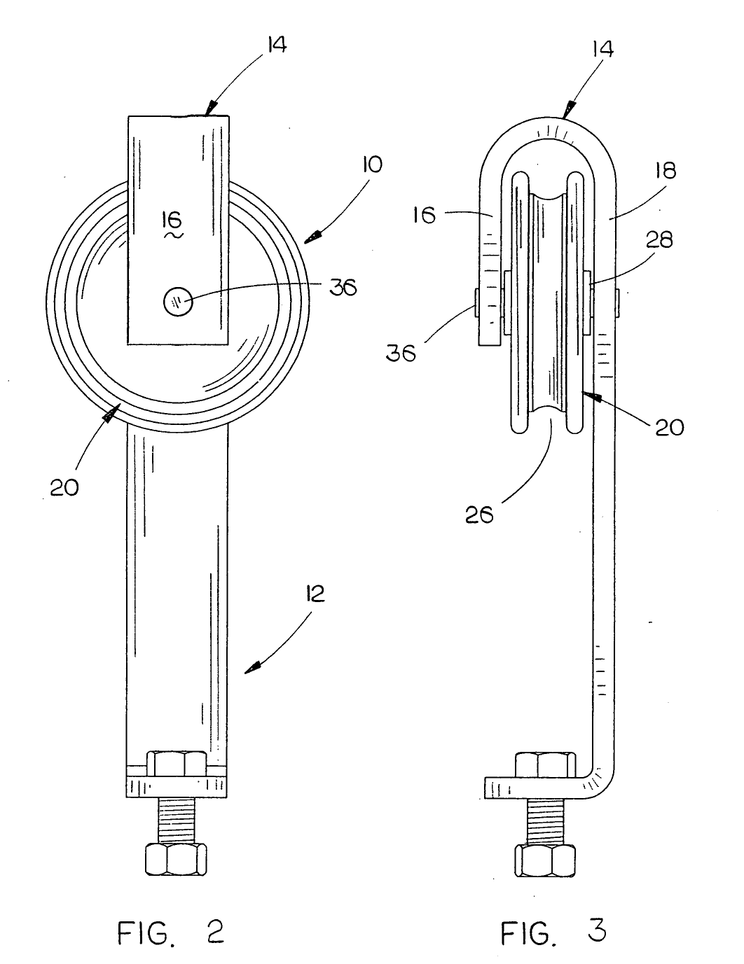

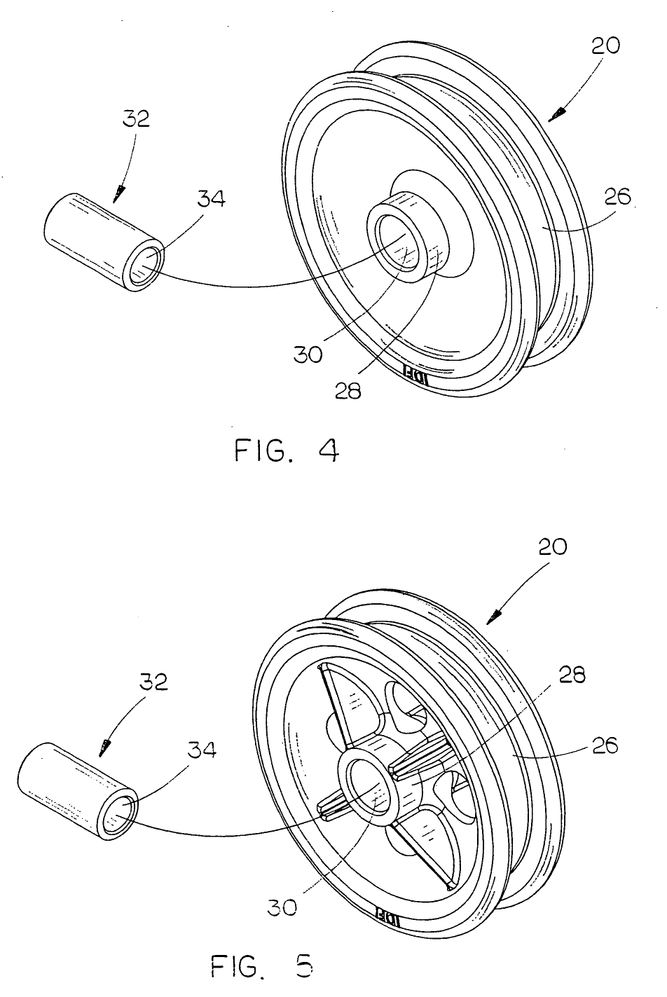

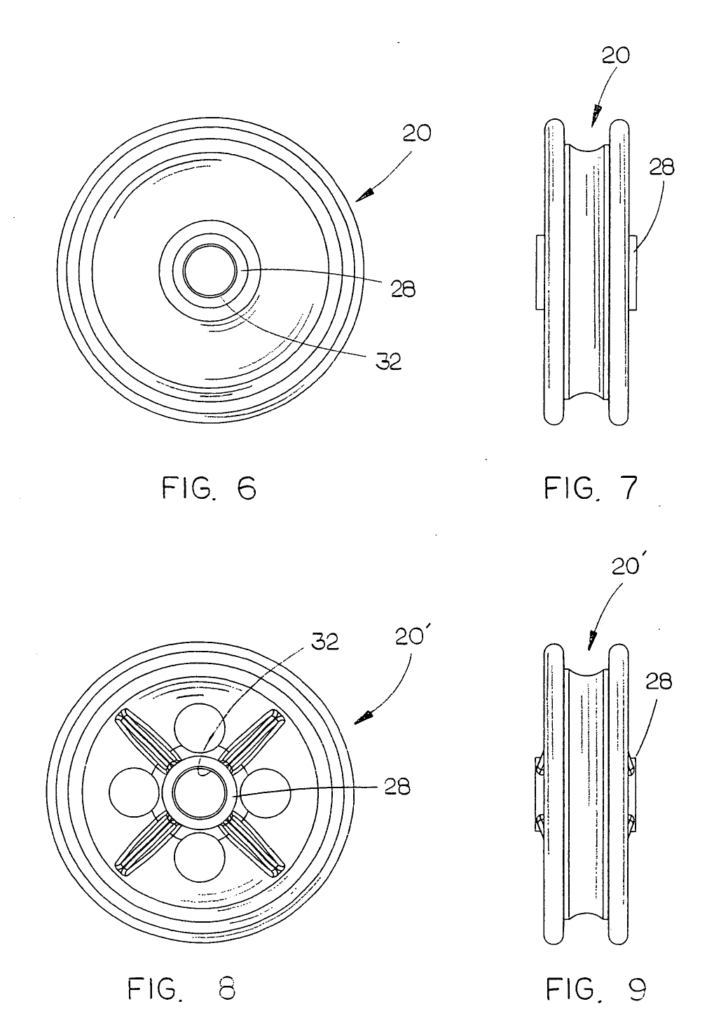

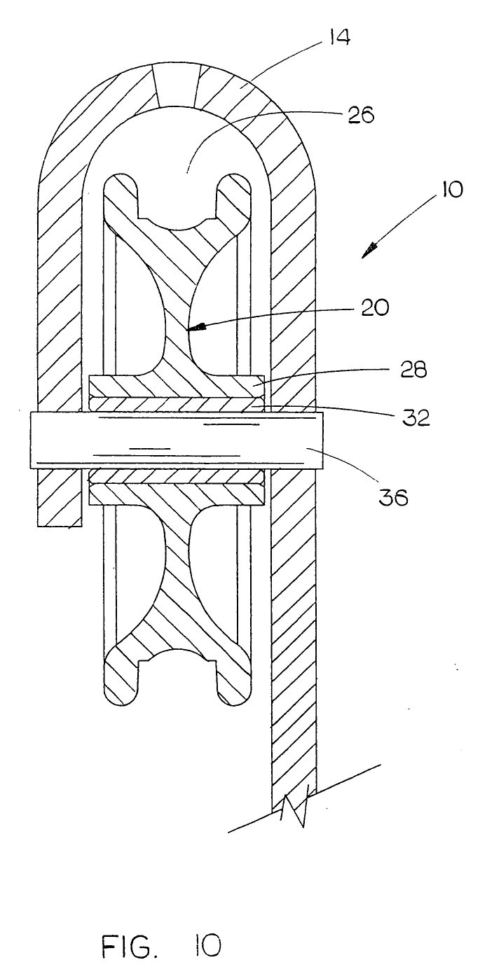

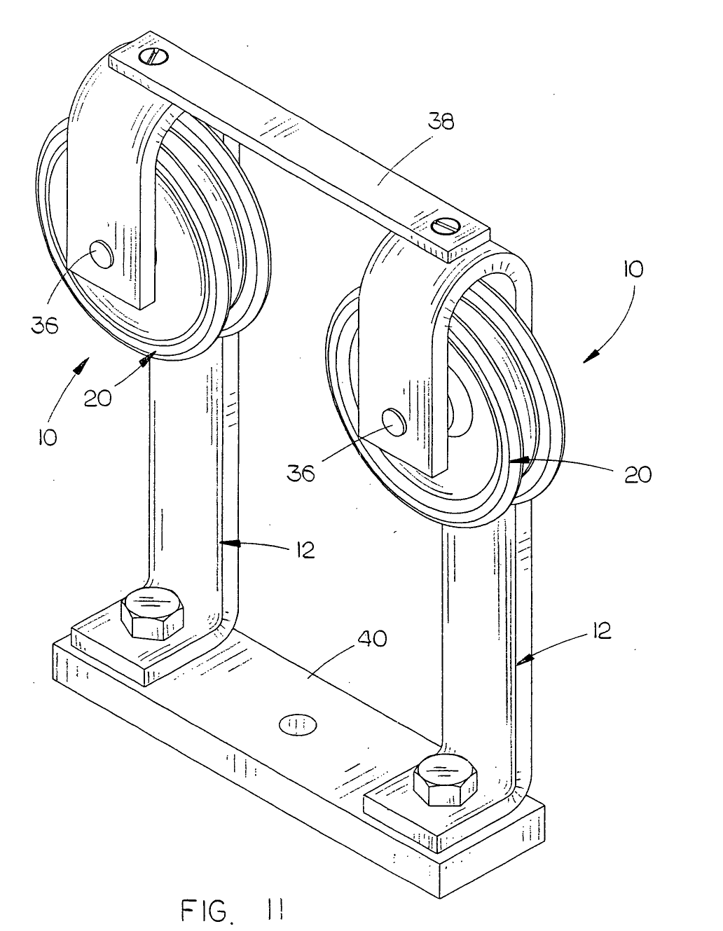

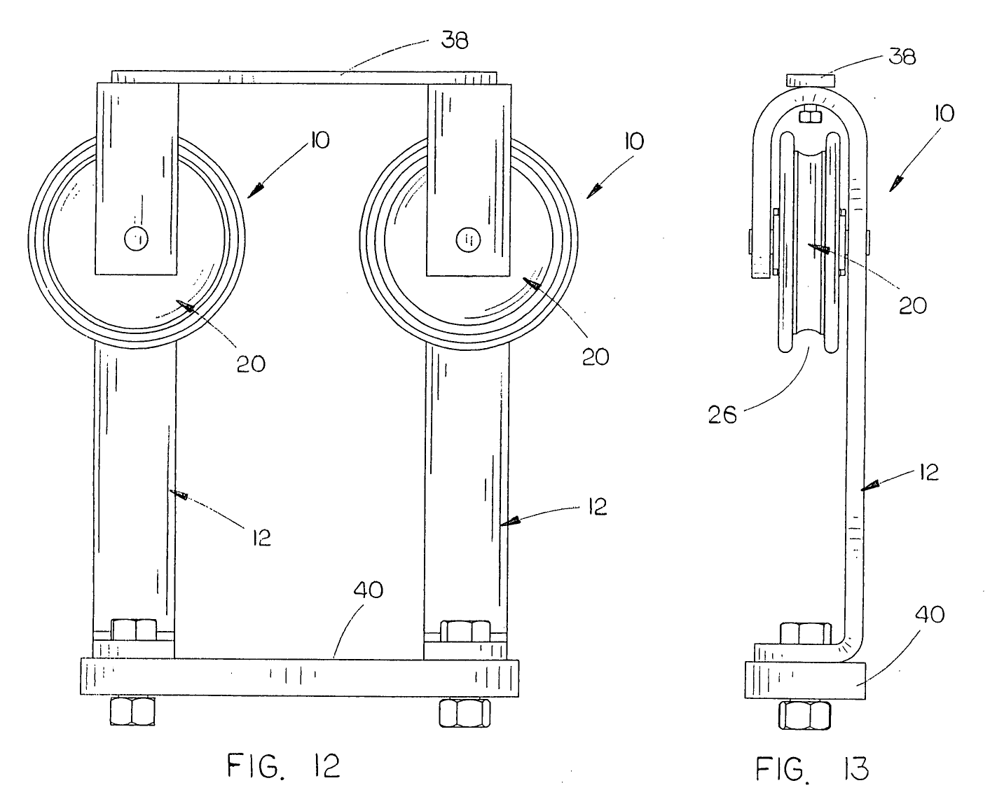

FIG. 1 illustrates a typical trolley wheel assembly which is referred to by the reference numeral 10. Assembly 10 includes a trolley bracket 12 having an inverted U-shaped portion 14 at its upper end which includes legs 16 and 18. The numeral 20 refers to a trolley wheel which includes opposite sides 22 and 24 and a groove 26 formed in the periphery thereof which is adapted to engage in and roll upon an overhead track of conventional design. Trolley wheel 20 includes a hub 28 having a central opening 30 extending therethrough. The numeral 32 refers to the bushing of this invention which is inserted into the central opening 30 of hub 28 for rotation with the trolley wheel 20. Bushing 32 includes a central opening 34 extending therethrough which receives pin 36 extending through the legs 16 and 18 and through the central opening 34 of bushing 32 to rotatably mount the trolley wheel 20 on the bracket 12.

Bushing 32 is comprised of a self-lubricating material. In one preferred embodiment, the self-lubricating material of the bushing 32 is comprised of Torlon®. Torlon® is comprised of a polyamide-imide material. The bushing 32 could also be comprised of a laminated plastic material made by impregnating fabric with thermosetting resins. Preferably, the bushing 32 is comprised of a non-metallic, high load, high impact, self-lubricating, laminate material. The bushing 32 may be comprised of a CIP® material. The bushing may be comprised of textiles and thermosetting resins blended with graphite, moly, PTFE and other lubricants.

When the trolley wheel assembly 10 is utilized on an overhead track to convey objects or products from one location to another within a plant or facility, the self-lubricating material of the bushing 32 as described above does not require oil or grease and is self-lubricating as described. The fact that the bushing 32 does not require oil or grease eliminates the possibility that oil or grease may drop from the trolley wheel assembly onto products or equipment therebelow.

FIG. 11 is a perspective view of a double or dual trolley wheel assembly which includes two trolley wheel assemblies 10 joined together at their upper ends by a brace or support 38 and their lower ends connected together by a brace or support 40. The trolley wheels 20 have the bushings 32 mounted therein as previously described.

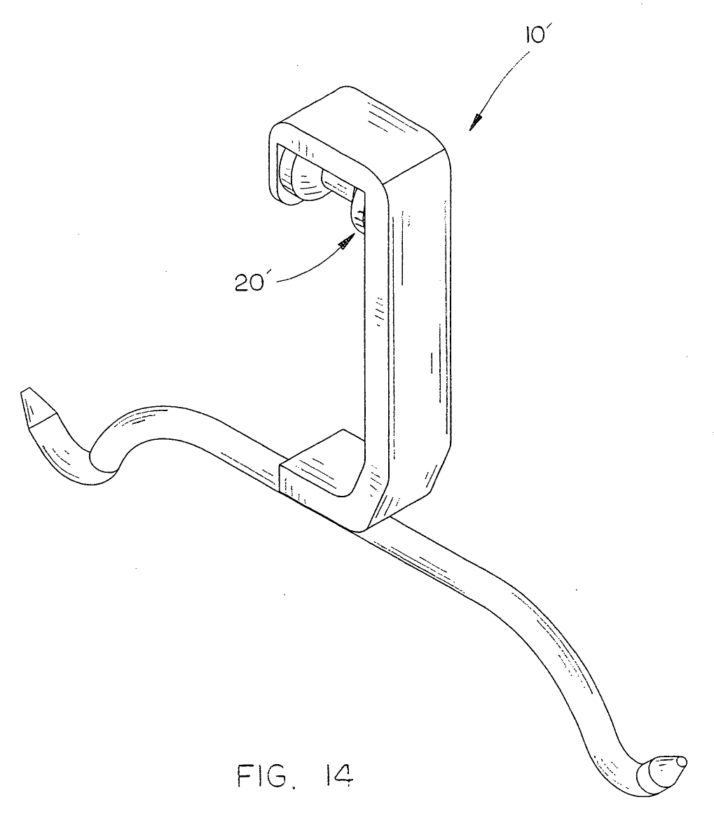

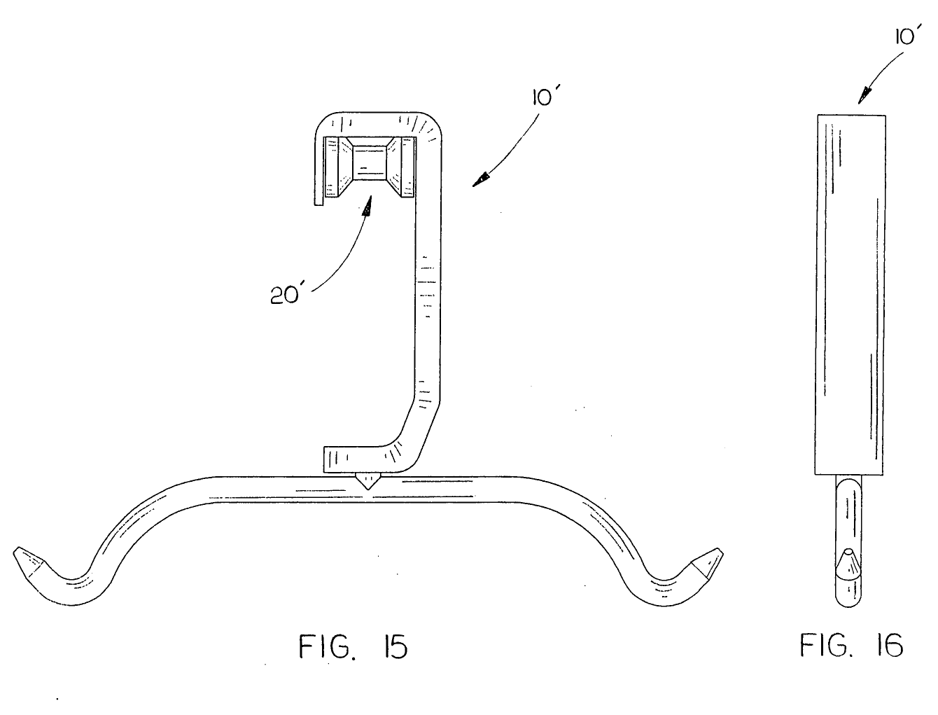

FIGS. 14 and 15 illustrate a modified form of the trolley wheel assembly which is referred to by the reference numeral 10′ and wherein the trolley wheel 20′ thereof includes a bushing identical to bushing 32 except for the dimensions thereof.

Thus it can be seen that a novel trolley wheel assembly has been provided which includes a self-lubricating or greaseless bushing in the trolley wheel thereof which does not require grease or oil which thereby prevents oil or grease from falling or dripping downwardly from the trolley wheel assembly onto products there below. It can therefore be seen that the invention accomplishes all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. A trolley wheel assembly for use on an overhead track, comprising:
a trolley bracket having upper and lower ends;
a trolley wheel rotatably secured to said trolley bracket and having first and second sides and a groove formed in the periphery thereof adapted to receive the overhead track;
said trolley wheel having a central opening formed therein;
a cylindrical bushing positioned in said central opening of said trolley wheel;
a pin means positioned in said bushing which is fixed to said trolley bracket;
said bushing being comprised of a self-lubricating material.

2. The trolley wheel assembly of claim 1 wherein said self-lubricating material is comprised of Torlon®.

3. The trolley wheel assembly of claim 1 wherein said self-lubricating material is comprised of a polyamide-imide material.

4. The trolley wheel assembly of claim 1 wherein said self-lubricating material is comprised of a laminate composite bearing material.

5. The trolley wheel assembly of claim 1 wherein said self-lubricating material is comprised of a laminated plastic material made by impregnating fabric with thermosetting resins.

6. The trolley wheel assembly of claim 1 wherein said self-lubricating material is comprised of a non-metallic, high load, high impact, self-lubricating, laminate material.

7. The trolley wheel assembly of claim 1 wherein said self-lubricating material is comprised of a CIP® material.

8. The trolley wheel assembly of claim 1 wherein said self-lubricating material is comprised of textiles and thermosetting resins blended with graphite, moly, PTFE and other lubricants.

9. The trolley wheel assembly of claim 1 wherein the trolley wheel is a double trolley wheel assembly.

10. The trolley wheel assembly of claim 1 wherein a pair of spaced-apart trolley wheel brackets are joined together at their upper and lower ends and wherein a trolley wheel is rotatably secured to each of said trolley wheel brackets, with each of the trolley wheels having a bushing mounted thereon which is comprised of the said self-lubricating bearing material.
